(19) United States
(12) Patent Application Publication
(10) Pub. No.: US 2023/0324018 A1
(43) Pub. Date: Oct. 12, 2023

(54) IMPROVED LIGHTING DEVICE

(71) Applicant: GREEN TECH INNOVATIONS, Metz (FR)

(72) Inventor: David CHQUIRY, HAGONDANGE (FR)

(21) Appl. No.: 18/043,394

(22) PCT Filed: Aug. 30, 2021
(86) PCT No.: PCT/EP2021/073826

§ 371 Date: Feb. 28, 2023

(30) Foreign Application Priority Data
Aug. 28, 2020 (FR) FR2008773

(51) Int. Cl. F21S 9/03

(52) U.S. Cl. CPC F21S 9/03

(57) ABSTRACT

The present invention relates to a lighting device powered at least partially by at least one energy storage means (3), comprising at least one lighting means (1), characterized in that it further comprises at least one ancillary means (2) for delivering a secondary service that consumes electricity, a controller (5) and a sensor for sensing an environmental factor (6), and in that the data from the sensor for sensing an environmental factor (6) are used by the controller (5) in combination with the charge level of the energy storage means (3) to control the activation or deactivation of the ancillary means (2). The present invention also relates to an assembly of several lighting devices according to the invention. The invention finally relates to a method for controlling a lighting device.

The present invention is in the field of lighting. It relates more particularly to a lighting device such as an improved street light.

For economic and environmental reasons, it is important to optimize energy consumption in all fields. In the field of urban lighting, there have been few changes over recent decades. Most of the street lights are still powered by power plants that are nuclear or emit CO2, energies which are costly and have a high negative impact on the environment. In addition, today's most widely used street lights emit a constant light, the emission level of which is sometimes unnecessarily high, which generates environmental light pollution.

Document EP2939503 proposes a street light equipped with a renewable energy source and a battery. A method for dynamically controlling the power supply makes it possible to manage the energy remaining in the battery by modulating the emission power of the street light. However, this results in less effective lighting at times, which may be detrimental to public safety.

Document MC200170 proposes a street light with a hybrid power supply, comprising a solar panel and an access to an electric grid. However, the power consumption of the street light is not adjusted depending on the environment, it is therefore not optimal.

An object of the present invention is to provide continuous lighting while reducing the energy consumption produced outside the device.

Another object of the present invention is to propose a street light for which the energy consumption by the lighting is optimal.

Another object of the present invention is to make better use of the energy produced by the device beyond the needs required for lighting.

The object of the present invention is to at least partially address the aforementioned objects by proposing a lighting device that can store energy usable for lighting and an ancillary service, the activation of the ancillary service depending on at least one environmental factor. For this purpose, it proposes a lighting device powered at least partially by at least one energy storage means, including at least one lighting means, characterized in that it further includes at least one ancillary means for delivering a secondary service that consumes electricity, a controller and at least one sensor of an environmental factor, and in that the data from said sensor of an environmental factor are used by the controller in combination with the charge level of said energy storage means in order to control the activation or deactivation of the ancillary means.

By virtue of these provisions, the energy available beyond the lighting needs may be used for the secondary service, which may avoid losing it, and the energy may be managed so as to prioritize the lighting service on the secondary service, the data from the at least one sensor of an environmental factor with which to refine the consumption predictions and therefore allow more optimal management of the available energy.

According to other features:
said device sensing an environmental factor may be a pollution sensor, a brightness sensor, a fog sensor or a rain sensor, these factors make it possible to effectively estimate the current and future lighting needs near said device,
said controller may use the data from the operating history of the lighting device for the control of said at least one ancillary means, so as to further refine the consumption predictions and thus to manage the available energy more optimally,
the controller may be capable of controlling activation in degraded mode of said at least one ancillary means, thereby avoiding deactivating the ancillary means if the available energy allows it, while saving energy compared to full activation,
the ancillary means may be selected from the list consisting of a camera, an air quality sensor, a microphone, a digital sign panel, a loudspeaker, a grid access terminal, and an electric vehicle charging terminal, which are means capable of delivering useful services in urban or rural environments,
said lighting device may further comprise means for connecting to an electricity distribution grid, wherein said controller controls the supply of the lighting means either by the energy storage means, or by the electricity distribution grid, which serves to guarantee continuity of service, in particular for lighting,
said controller may control the intensity and/or color of the light emitted by the lighting means according to at least one external parameter, which makes it possible to save energy and reduce light pollution,
said lighting device may comprise a brightness sensor, wherein said external parameter is the brightness, which makes it possible to refine at any moment the intensity and/or the color of the lighting most relevant to the environment of the lighting device,
said energy storage means may be powered at least partially by at least one photovoltaic panel, which allows it to be supplied at least in part by renewable energy, not emitting CO2, and reduces its dependency on an electric grid, or even makes fully independent operation possible.

The present invention also relates to an assembly comprising a plurality of devices according to the invention, said devices being connected to an electric grid allowing the transfer of energy between the energy storage means of a first lighting device and the energy storage means of a second lighting device.

By virtue of these provisions, a better energy use can be done at the grid level, the lowest energy producing and/or the greatest energy consuming devices being able to benefit from the energy surplus from the greatest energy producing and/or the lowest energy consuming devices, which reduces the power consumption from sources outside the devices, or even increases the possibilities of a fully autonomous operation.

The present invention finally relates to a method for controlling a lighting device, said device being able to deliver lighting and at least one secondary service, wherein said secondary service may be activated, deactivated or, if appropriate, activated in degraded mode, according to an environmental factor measured by a sensor of an environmental factor of said device, and the state of charge of an energy storage means of said device.

By virtue of these provisions, the energy available beyond the lighting needs may be used for the secondary service, which may avoid losing it, and the energy may be managed so as to prioritize the lighting service over the secondary service, the data from the sensor of an environmental factor making it possible to refine the consumption predictions and therefore to allow more optimal management of the available energy.

The present invention will be better understood on reading the following detailed description, with reference to the appended figures, in which:

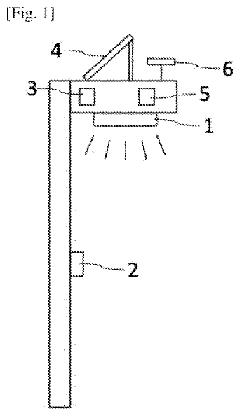

FIG. 1 is a schematic view of a lighting device according to a preferred embodiment of the invention.

The lighting device according to the invention, an embodiment of which is shown in FIG. 1, includes a lighting means 1. The lighting means 1 preferably comprises at least one light-emitting diode, which makes it possible to reduce the energy consumption.

The lighting means may preferably emit light at the adjustable intensity and/or color. The choice of the type of light emitted may then be done on the basis of at least one external parameter. Such an external parameter may be the brightness, measured for example by a brightness sensor present on the device according to the invention. Other parameters may be used, such as passage near the device, detected by a presence sensor.

The lighting device also includes an ancillary means 2, for delivering a secondary service that consumes electricity separate from the lighting. The ancillary means 2 may for example be a camera, an air quality sensor, a microphone, a digital sign panel, a loudspeaker, a grid access terminal, or still an electric vehicle charging terminal.

The lighting device is at least partially powered by an energy storage means such as a battery 3. The battery 3 may be powered, for example, by an element forming part of the lighting device such as a photovoltaic panel 4 or a wind turbine.

The lighting device also includes a controller 5 and a sensor of an environmental factor 6. The level of the environmental data measured, optionally with other factors taken into account, determines the lighting needs in the coming hours. For example, if the sensor of an environmental factor 6 records degraded environmental data (pollution, fog, rain, very low brightness, etc.), it may be necessary to increase the lighting power, or to turn the lighting means 1 on earlier at night or some dark times of the day, or to leave it on later in the morning. The controller 5 therefore uses the data from a sensor of an environmental factor to anticipate the energy needs of the lighting means 1. Depending on the battery charge level, it may then decide to activate or deactivate the ancillary means 2. The deactivation of the ancillary means 2 for example makes it possible to keep the energy stored in the battery 3 longer, and allows the lighting means 1 to be powered by the battery 3 until the end of the night. According to the type of ancillary means 2, the controller may also put the ancillary means 2 in a degraded mode, in which the consumed energy level is reduced. For example, for an air quality sensor it may be measurements at a reduced frequency; for a digital sign panel or speaker a reduction in the emission power; for a grid access terminal, a reduction in the number of allowed connections, etc.

The sensor of an environmental factor 6 may be a pollution sensor. Since pollution is a slowly changing factor, such a sensor offers the advantage of allowing longer term predictions of the lighting needs.

In order to optimize the management of the energy stored in the energy storage means 3 by the controller 5, the controller 5 may also use the information from the operating history of the lighting device. This history may include in particular information on the hours of turning the lighting means 1 on and off, with the color and intensity parameters where appropriate, and on the past consumption of the ancillary means 2.

In a preferred embodiment of the invention, the lighting device comprises means for connecting to an electricity distribution grid. This makes it possible to ensure continuity of the lighting, including in the event of complete discharge of the energy storage means 3. The management of the energy of the energy storage means 3 described above, through the activation or the deactivation of the ancillary means 2 by the controller 5, then makes it possible to minimize the energy used on the grid. The connection to the grid is only an insurance because a lighting service interruption is not acceptable. In this embodiment, the controller 5 controls the supply of the lighting means 1 and decides to supply the lighting means 1 either by way of the energy storage means, or the electricity distribution grid. This command may be carried out by means of a switch with at least two states. It is also possible to use the electricity distribution grid to recharge the energy storage means 3.

The device according to the invention makes it possible for the consumption of electrical energy coming from the electric grid to be reduced, when the energy storage means 3 is powered by an element internal to the device. However, in certain cases, for example on sunny days, if the device includes a photovoltaic panel, it may happen that the energy it produces is greater than the needs of the lighting means. The device according to the invention then makes it possible not lose the excess energy produced by the device, because it may be consumed by the ancillary means 2, in order to deliver one or more secondary services.

Several devices according to the invention may be gathered in an assembly in which each device is connected to an electric grid. This electric grid, which may be dedicated to the devices according to the invention, allows the transfer of energy between different devices. The assembly may include devices whose energy storage means 3 have a lot of available energy, while others have little energy: a transfer of energy from the former to the latter is therefore advantageous. These different charge levels may have different causes. It may involve the charge of the storage means 3: for example if they are powered by photovoltaic panels, some devices may be in the shade a large part of the day, while others are not. It may also involve different consumption profiles: the ancillary means 2 may consume more or less energy depending on the devices, for example a grid access terminal will consume more energy in a very busy area.

The electric grid connecting the devices of the assembly may be totally autonomous and include a green energy source, for example of photovoltaic or wind type.

The device assembly also makes it possible to network the controllers 5 with a central server, making it possible to group the data from each controller 5 and to make the data available to the other controllers 5. Thus, the management of their energy storage means 3 by the controllers 5 may benefit from a learning algorithm using the experiences of all the controllers 5 of the grid. This also makes it possible, during the installation in the assembly of a new device according to the invention, for the device to immediately use a management profile that already operates in other devices that were installed previously.

The present invention also relates to a method for controlling a lighting device according to the invention. In this method, the secondary service delivered by the device may be activated, deactivated or, if appropriate activated in degraded mode, according to an environmental factor measured by the sensor of an environmental factor 6, and the state of charge of the energy storage means 3.

Although the above description is based on particular embodiments, it in no way limits the scope of the invention, and modifications may be made, in particular by substituting technical equivalents or by combining some or all of the features developed above.

1. A lighting device powered at least partially by at least one energy storage means (3), including at least one lighting means (1), characterized in that it further includes at least one ancillary means (2) for delivering a secondary service that consumes electricity, a controller (5) and at least one sensor of an environmental factor (6), in that the data from said sensor of an environmental factor (6) are used by the controller (5) in combination with the charge level of said energy storage means (3) in order to control the activation or deactivation of the ancillary means (2) and in that said sensor of an environmental factor (6) is a pollution sensor, a fog sensor or a rain sensor.

2. The lighting device according to the preceding claim, wherein a sensor of an environmental factor (6) is a brightness sensor.

3. The lighting device according to one of the preceding claims, wherein said controller (5) uses the data from the operating history of the lighting device to control the activation or deactivation of said at least one ancillary means (2).

4. The lighting device according to one of the preceding claims, wherein the controller (5) may further control the activation in degraded mode of said at least one ancillary means (2).

5. The lighting device according to one of the preceding claims, wherein the ancillary means (2) is selected from the list consisting of a camera, an air quality sensor, a microphone, a digital sign panel, a loudspeaker, a grid access terminal, and an electric vehicle charging terminal.

6. The lighting device according to one of the preceding claims, further comprising a means for connecting to an electricity distribution grid, wherein said controller (5) controls the supply of the lighting means (1) either by the energy storage means (3), or by the electricity distribution grid.

7. The lighting device according to one of the preceding claims, wherein said controller (5) controls the intensity and/or color of the light emitted by the lighting means (1) as a function of at least one external parameter such as the brightness.

8. The lighting device according to one of the preceding claims, wherein said energy storage means (3) is powered at least partially by at least one photovoltaic panel (4).

9. An assembly comprising a plurality of devices according to one of claims 1 to 8, said devices being connected to an electric grid allowing the transfer of energy between the energy storage means (3) of a first lighting device and the energy storage means (3) of a second lighting device.

10. A method for controlling a lighting device according to one of claims 1 to 8, said device for delivering lighting and at least one secondary service, wherein said secondary service may be activated, deactivated or, if appropriate activated in degraded mode, according to an environmental factor measured by a sensor of an environmental factor (6) of said device, and the state of charge of an energy storage means (3) of said device.
